(19) United States
(12) Patent Application Publication
(10) Pub. No.: US 2013/0144651 A1
(43) Pub. Date: Jun. 6, 2013

(54) DETERMINING ONE OR MORE PROBABLE MEDICAL CODES USING MEDICAL CLAIMS

(71) Applicant: Gururaj Rao, Mumbai (IN)

(72) Inventor: Gururaj Rao, Mumbai (IN)

(73) Assignee: INFOSYS LIMITED, Bangalore (IN)

(21) Appl. No.: 13/425,907

(22) Filed: Mar. 21, 2012

(30) Foreign Application Priority Data
Dec. 5, 2011 (IN) 4196/CHE/2011

(51) Int. Cl. G06Q 50/24

(52) U.S. Cl. 705/3; 705/2

(57) ABSTRACT

Disclosed herein is a system which addresses the problem of multiple mappings of a source ICD code to a target ICD code by using medical service claim records. The mechanism is based on analysis of the ICD code description, and analysis of accompanying data to determine a set of selection parameters to assist in the conversion. Implementation of selection parameters is disclosed. These are applied in the form of first and second axis of differentiation.

### RELATED APPLICATION DATA

This application claims priority to Indian Patent Application No. 4196/CHE/2011, filed Dec. 5, 2011, which is hereby incorporated by reference in its entirety.

### FIELD OF THE INVENTION

The present disclosure relates in general to the field of medical information management, and more particularly, to a system and method for processing an incoming ICD code by using structured data, such as medical claims and mapping information, for use in supporting health care or other organization, for example.

### BACKGROUND OF THE INVENTION

Classification involves the categorization of relevant concepts for the purposes of systematic recording or analysis. The categorization is based on one or more logical rules. To this end, WHO has developed reference classifications that can be used to describe the health state of a person at a particular point in time. Diseases, treatment procedures and other related health problems, such as symptoms and injury, are classified in the International Classification of Diseases (ICD). A classification of diseases may be defined as a system of categories to which morbid entities are assigned according to established criteria. The ICD is used to translate diagnosis of diseases and other health problems from words into an alphanumeric code, which permits easy storage, retrieval and analysis of the data.

The International Classification of Diseases 10th Revision Procedure Classification System (ICD-10-PCS) and ICD-10-CM have been developed as a replacement of the International Classification of Diseases 9th Revision (ICD-9-CM). In ICD-9-CM, the methodology for assigning a code is the same for diagnosis code and procedure code. ICD-10-CM and ICD-10-PCS use different methodologies for assigning codes. ICD-10-CM defines the code set used to report inpatient and outpatient diagnoses. ICD-10-PCS defines the code set used to report inpatient procedures. The traditional ICD structure has been retained but an alphanumeric coding scheme replaces the previous numeric one. This provides a larger coding frame and leaves room for future revision without disruption of the numbering system.

Mapping from a reference terminology to a classification is not straightforward. There are multiple scenarios that may arise while mapping a source ICD code to a target code. For the purpose of an illustration, FIG. 1 (PRIOR ART) is representative of the various scenarios that may exist. 110 represents a scenario where a source ICD code has a one to one mapping to a target ICD code. 120 and 130 represent more complicated situations where one source ICD code is linked to one or more target ICD codes or one source ICD code is linked to a combination of target ICD codes. 120 shows a single ICD-9-CM source code set on the left side with multiple mappings of the same to the ICD-10-PCS target code set on the right side. Similarly, 130 shows a single ICD-10-PCS source code set on the left side with multiple mappings of the same to the ICD-9-CM target code set on the right side. ICD-10 is much more specific, for diagnoses, there are 14,025 ICD-9-CM codes and 68,069 ICD-10-CM codes; and for procedures, there are 3,824 ICD-9-CM codes and 72,589 ICD-10-PCS. Therefore, one ICD-9-CM diagnosis or procedure code may be represented by multiple ICD-10 diagnosis code or procedure codes and one ICD-10 Diagnosis Code or Procedure Code may be represented by multiple ICD-9-CM codes.

In US, the Centers for Medicare & Medicaid Services (CMS) and the Centers for Disease Control and Prevention has created the national version of the General Equivalence Mappings (GEM) to ensure that consistency in mapping from ICD9 to ICD10 is maintained. Oct. 1, 2013 is the compliance date for implementation of ICD-10 for all covered entities. The GEMs can be used by anyone who wants to convert coded data, including, but not limited to, payers, providers, medical researchers, informatics professionals, coding professionals, organizations. Because of the transition from version 9 to 10, there may be a need to understand the financial and clinical impact of this transition. For example, in coding individual claims, it will be more efficient and accurate to select the appropriate code(s) from the reference mapping by using associated medical record documentation. However, in many situations, particularly, on the payer's side, the clinical notes may be unavailable. Further, there stands a chance to a large number of variations as the medical personnel may write the medical note in their own handwriting, using their own vocabulary. Currently, most hospitals rely on manual extraction of information from patient records, requiring many extractors. Manual extraction can result in missed data. One effective way of correlating old codes with the new reduced set of codes is by automatically extracting information from the medical claims and using this information to reduce to one or more target ICD codes.

FIG. 2 (PRIOR ART) represents an exhibit, 200, of an 837 claim. 837 claims are submitted by providers to one or more payers for the purpose of reimbursements. These claims are highly dependent on medical codes, particularly ICD codes, as these are used to determine the services rendered during the treatment. 200 is an outline representing the hierarchical structure of the loops and segments for the 837 claim. The 837 format supports two segments that can be used to support data needs. The syntax is organized by loops, segments, and data elements. Loops are made up of segments and segments are made up of data elements. Each data element is variable length with the standard minimum and maximum length. The loops are organized by categories of information. In the 837 format related categories of information are associated by their hierarchy as defined by a hierarchical level (HL) segment. Proper coding of this HL segment allows for information on multiple providers to be reported as well as information for multiple patients for each provider to be reported. The ICD codes listed in the claim i.e. the source ICD codes state the symptoms and treatment details of the patient. Under the HIPAA Regulations, when code sets change over this occurs on a specific date. Claims incurred prior to that date are submitted with the old codes. Claims incurred after that date are to be submitted with the new codes. Further, as per the treatment the conversion of code may differ from one hospital to another. For example, hospital A might dictate to Payer A that the proper mapping for them is to 362.01 and Hospital B might dictate to Payer A that the proper mapping for them is 362.07. In this situation, there is a need to determine the appropriate target ICD code considering the hospital and the historical data. Other data formats, which include, but not limited to, UB04, could also be used to determine the appropriate target ICD code.

Disclosed herein are methods and systems of extrapolating and converting a source ICD code to a target ICD code based on information extracted from medical service claim records.

### SUMMARY OF THE INVENTION

Aspects of the disclosure relate to a system and method for automatic conversion of a source ICD code to one or more target ICD codes. An implementation of the disclosure addresses the problem of the 1: n mapping between different versions of ICD by using the medical service claim records to generate one or more target ICD code.

According to the disclosed system, the system comprises a code analyzer module for applying a set of selection parameters classified as the first and second axis of differentiation to obtain a reduced set of target ICD codes.

In another aspect of the disclosure, a correlation repository is used to obtain a reduced set of target ICD codes based on body part selection parameter.

The above as well as additional aspects and advantages of the disclosure will become apparent in the following detailed written description

### BRIEF DESCRIPTION OF THE DRAWINGS

The aspects of the disclosure will be better understood with the accompanying drawings.

FIG. 1 (PRIOR ART) is representative of the reference mapping from one ICD code set to another;

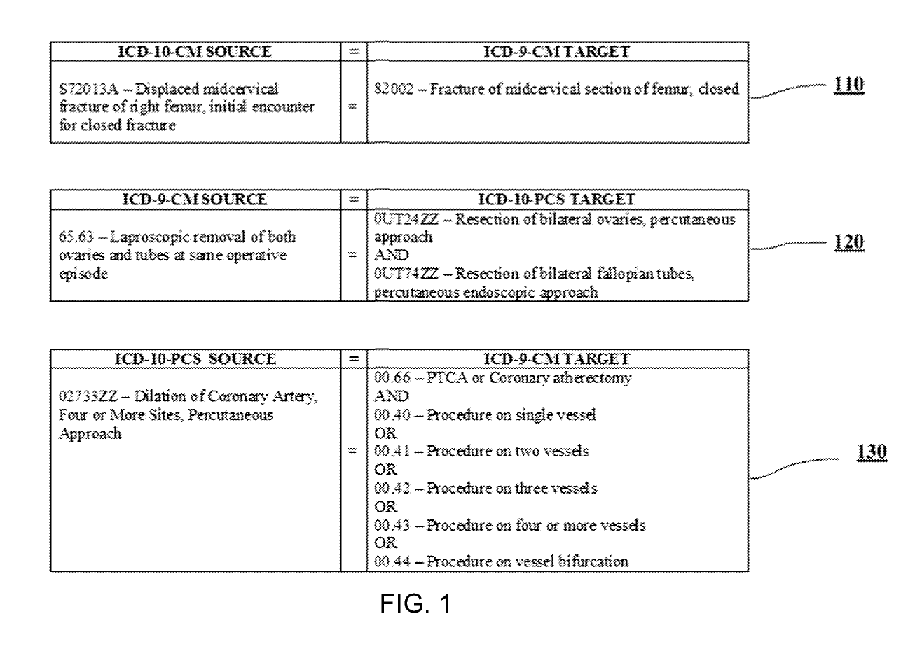

FIG. 2 (PRIOR ART) represents an exhibit of an 837 claim which is submitted by providers to one or more payers for the purpose of reimbursements;

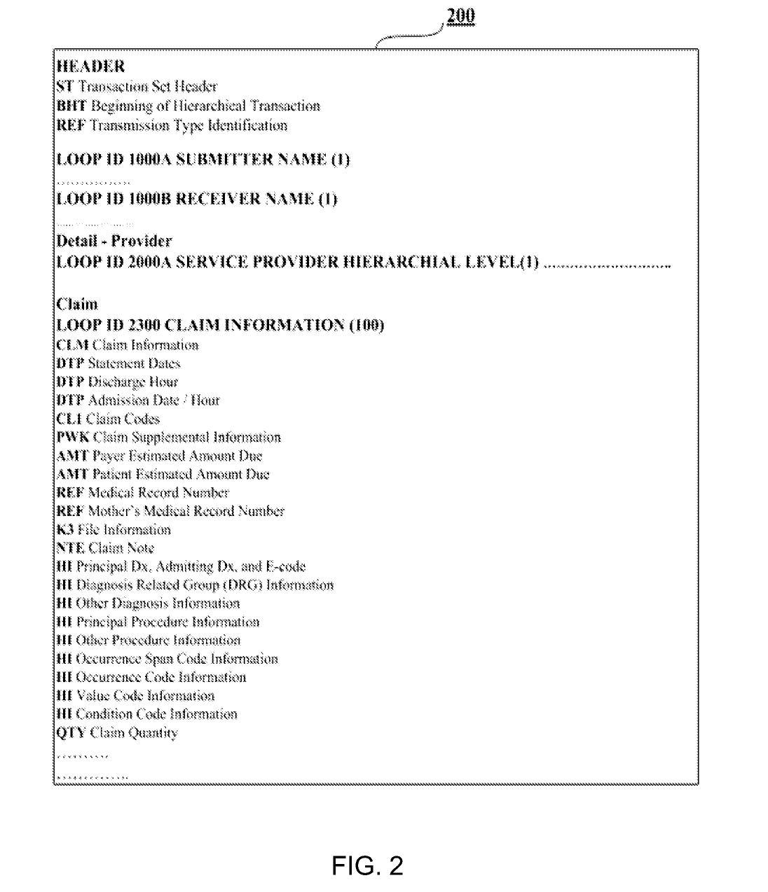

FIG. 3 is a block diagram of a computing device to which the present disclosure may be applied;

FIG. 4 shows an exemplary architecture for obtaining a reduced set of target ICD codes;

FIG. 5, in conjunction with FIG. 6, shows an exemplary process with the flow of steps for obtaining a reduced set of target ICD codes. Gives an overview of the method used to automatically find and assign the target ICD code(s); and

FIG. 6 (PRIOR ART) is an example to illustrate the approach selection parameter.

While systems and methods are described herein by way of example and embodiments, those skilled in the art recognize that systems and methods disclosed herein are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include”, “including”, and “includes” mean including, but not limited to.

### DETAILED DESCRIPTION

Disclosed embodiments provide computer-implemented methods, systems, and computer-readable media for converting a source ICD code to a target ICD code. To facilitate a clear understanding of the present disclosure, illustrative examples are provided herein which describe certain aspects of the disclosure. However, it is to be appreciated that these illustrations are not meant to limit the scope of the disclosure, and are provided herein to illustrate certain concepts associated with the disclosure.

It is also to be understood that the present disclosure may be implemented in various forms of hardware, software, firmware, special purpose processors, or a combination thereof. Preferably, the present invention is implemented in software as a program tangibly embodied on a program storage device. The program may be uploaded to, and executed by, a machine comprising any suitable architecture.

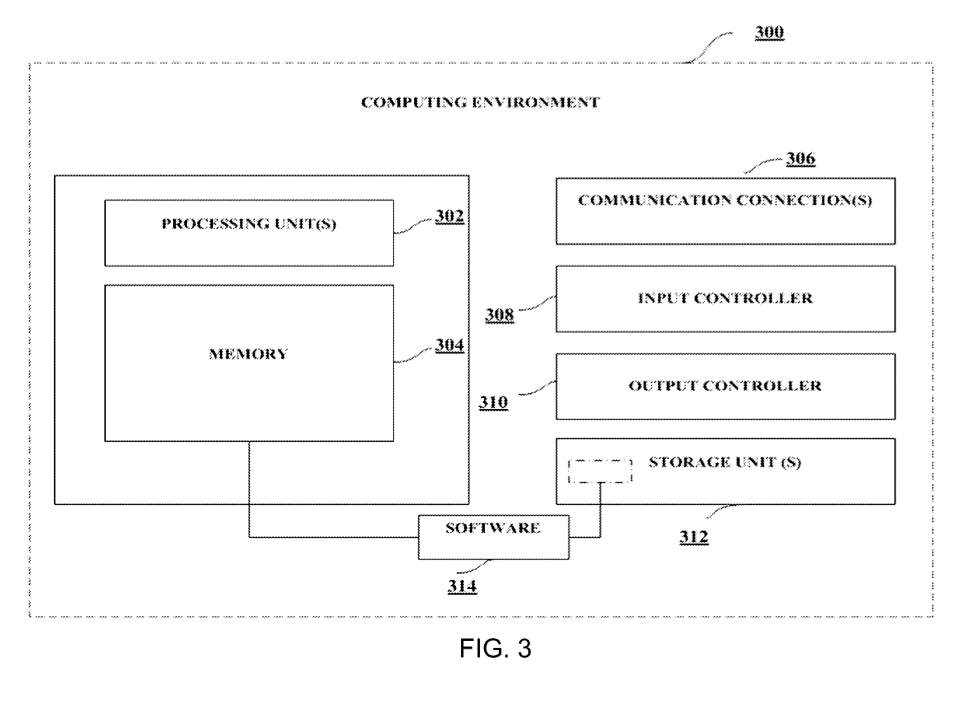

FIG. 3 is a block diagram of a computing device 300 to which the present disclosure may be applied according to an embodiment of the present disclosure. The system includes at least one processor 302, designed to process instructions, for example computer readable instructions (i.e., code) stored on a storage device 312. By processing instructions, processing device 302 may perform the steps and functions disclosed herein. Storage device 312 may be any type of storage device (e.g., an optical storage device, a magnetic storage device, a solid state storage device, etc.), for example a non-transitory storage device. Alternatively, instructions may be stored in one or more remote storage devices, for example storage devices accessed over a network or the internet. The computing device also includes an operating system and microinstruction code. The various processes and functions described herein may either be part of the microinstruction code or part of the program (or combination thereof) which is executed via the operating system. Computing device 300 additionally may have memory 304, an input controller 308, and an output controller 310. A bus (not shown) may operatively couple components of computing device 300, including processor 302, memory 304, storage device 312, input controller 308, output controller 310, and any other devices (e.g., network controllers, sound controllers, etc.). Output controller 310 may be operatively coupled (e.g., via a wired or wireless connection) to a display device (e.g., a monitor, television, mobile device screen, touch-display, etc.) in such a fashion that output controller 310 can transform the display on display device (e.g., in response to modules executed). Input controller 308 may be operatively coupled (e.g., via a wired or wireless connection) to input device (e.g., mouse, keyboard, touch-pad, scroll-ball, touch-display, etc.) in such a fashion that input can be received from a user. Of course, FIG. 3 illustrates computing device 300 with all components as separate devices for ease of identification only. Each of the components may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 300 may be one or more servers, for example a farm of networked servers, a clustered server environment, or a cloud network of computing devices.

The disclosure herein proposes systems and methods that can be applied to both, forward mapping and backward mapping, with the objective of automatically finding or reducing the correct set of target ICD code(s) from the source ICD code. As used herein, the term ‘Backward Mapping’ means mapping from a later version of an ICD code set to an earlier version of an ICD code set. As used herein, the term ‘Forward Mapping’ means mapping from an earlier version of an ICD code set to a later version of an ICD code set. The basis of the system is the GEM provided by CMS. The term ‘Source Code Set’ means the code set of origin in the mapping i.e. the set being mapped from whereas the term As ‘Target Code Set’ means the destination code set in the mapping i.e. the set being mapped to.

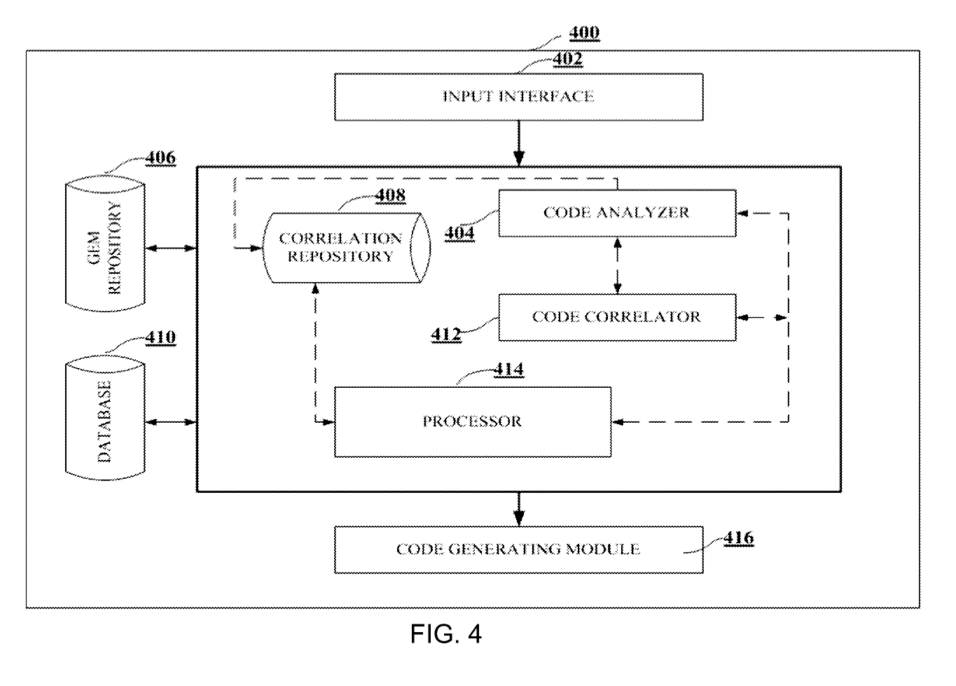

Referring now to FIG. 4, which is an exemplary architecture 400 for obtaining a reduced set of target ICD codes. 400 is a block diagram of a system depicting the automated conversion from a source ICD code to a target ICD code. The input interface 402 accepts data in the form of a file. The input terminal receives one or more incoming medical service claim records which are used to identify one or more diagnostic and procedure ICD codes; Tokens are generated from the target ICD code descriptions. The term ‘token’, as used herein, refers to singular words which are obtained by parsing the ICD code descriptions. The system may be configured to store these tokens in a token repository. Since the generated tokens can be optionally stored in a repository, these pre-generated tokens can be used for subsequent conversions of a source ICD code to a target ICD code. The code analyzer 404 invokes the rules to apply a set of selection parameters. These selection parameters are applied to the target ICD codes which are retrieved by referring to the mapping of source ICD code from GEM repository 406. The choice of selection parameters to be applied may be configured in the system. The system may be configured to apply one, all or certain selection parameters as per the requirement. These selection parameters are used by in conjunction with the correlation repository 408 and code correlator 412. The system may optionally refer to external databases 410 which aid in correlating the potential target ICD codes so as to obtain the reduced set of target ICD codes. The correlation repository 408 is used to correlate potential target ICD procedure code tokens with one or more stored repository of body parts. The code correlator 412 allocates actual values to virtual buckets, which will be described in detail. A processor 414 performs the statistical analysis and sends the results to the code generating module 416.

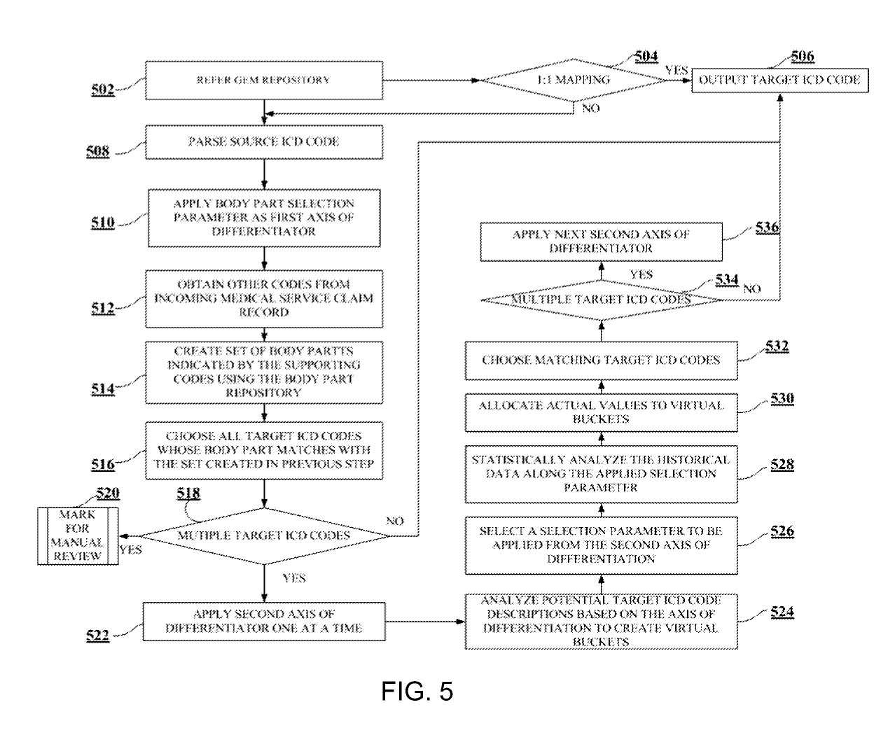

Referring now to FIG. 5, which is a schematic representation of the method used to automatically locate the target ICD codes. The source ICD codes are obtained from the pertinent loop and segment of the medical service claim record. The ICD codes are extracted from the incoming medical codes and the input can be accepted in the form of a file or the codes. The file is parsed to obtain the ICD codes which will serve as an input for the automated process for finding the correct set of target codes. The file can be received in a variety of digital formats, including, but not limited to Electronic Data Interchange (EDI) format or Uniform Bill (UB). The potential target ICD codes are obtained by making a reference to the GEM repository. For every source ICD code (both, PCS and CM), the GEM mapping of the source ICD code is determined by making a reference to the GEM repository 502. If the GEM repository returns a 1:1 mapping 504 then the target ICD code is stored as an output 506. If the GEM repository returns multiple target ICD codes then the target ICD code descriptions of the potential target ICD codes are parsed 508 to obtain tokens. As used herein, the term ‘Target Code Description’ means the descriptions of the scenarios and choice lists as well as codes as per the GEM mapping. These potential target ICD codes will be organized using a set of selection parameters. The selection parameters, classified as the first axis of differentiation and the second axis of differentiation, are then used to narrow down the list of potential target ICD codes by removing those target ICD codes that have no connection with the medical claim. A first axis of differentiation is applied 510 as a body parameter selection parameter. The body part is the specific anatomical site where the procedure was performed. Examples of body parts are Kidney, Thymus, Lower Arm and Tonsils. The tokens obtained by parsing the target ICD code descriptions are compared to a correlation repository. It serves as an input for the repository of body parts. Preferably the correlation repository is created at the time of compilation. The additional ICD codes are extracted from the medical service claim record 512, for example, diagnosis codes and secondary codes to correlate with the correlation repository and narrow down the target ICD codes. Specifically, a set of body parts are created that are indicated by the supporting codes and using the repository. The potential target ICD code tokens are correlated with the correlation repository of body parts 514. The subset of target ICD codes whose body part matches with the set of body parts created above is stored as the result set for the application of body part selection parameter. In one embodiment of the disclosure, the system refers to external sources for fetching associations to the target code descriptions. These sources can aid in creating an association. Each association may be described by lexical type, semantic type and a list of contexts in which the synonyms would be applicable. Typical lexical types include acronyms, abbreviations, prefixes, suffixes etc., while a semantic type may include a synonym. The synonyms would function as what could constitute as something close enough in context and function. For example, the description of a disease will include a body part. The external sources which may be referred include, but not limited to, SNOMED (Systemized Nomenclature of Medicine). SNOMED is a standardized, multilingual vocabulary of clinical terminology that is used by physicians and other health care providers for the electronic exchange of clinical health information. It represents the approach of projecting medical concepts into distinct semantic dimensions and listing the terms for elementary concepts in a hierarchic structure.

If the application of a first axis of differentiation does results in a one on one mapping of the source ICD code to the target ICD code 518 then the target ICD code is sent as an output 506 by the system. Alternatively, the rules may be configured to send the result set of body part selection parameter for a manual review 520. In typical situations this may be done when the result set of first axis of differentiation can be easily traversed to select the desired target ICD code or in situations where the payer, for example, wants to conduct a manual review to make an entry of the same in the correlation repository for future analysis. If the application of body part selection parameter gives more than one target ICD code then a second axis of differentiator is applied by the system 522. The second axis of differentiation constitutes age, cost and approach parameters. The various types of second axis of differentiation are applied, one at a time, to obtain a minimal possible set of target ICD codes. The second axis of differentiates includes, but not limited to cost selection parameter, age selection parameter and approach selection parameter. As used herein, the term approach is the technique used to reach the procedure site. As used herein, the term age denotes the age of the patient who has undergone the treatment and for whom the incoming medical claim is presented. The order of application of selection parameters may be pre-defined in the system in the form of rules. Alternatively, user may be given an option at run-time to select the desired second axis of differentiation to be applied. For the purpose of an illustration, if the order of selection parameter application for the second axis of differentiation is pre-defined for approach selection parameter as the first selection parameter, then the potential target ICD code descriptions are analyzed to create virtual buckets 524. Alternately the virtual buckets could also be created at the time of compilation and stored.

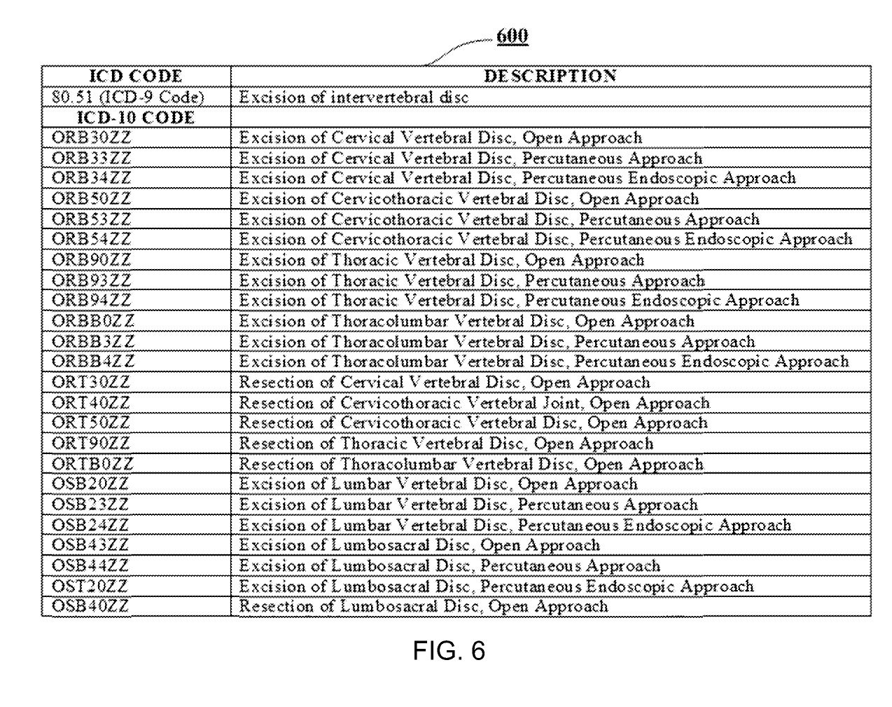

Referring now to FIG. 6, in conjunction with FIG. 5, which is illustration of 80.51 (Excision of intervertebral disc) ICD-9 code mapping to ICD-10 system. The payer represented with a medical service claim record with ICD-9 code 80.51 has several options to select from. The reimbursements will vary with the type of procedure performed on the patient. For example, a patient suffering from spinal cord requiring a surgical procedure needing discectomy may undergo different types of procedures. Based on the type of approach used, the length of stay in the hospital will vary. A minimally invasive discectomy versus and discectomy technique would relate to different lengths of stay and hospital costs. Minimally invasive technique would typically have a shorter hospital stay. Further, the length of stay may vary with the type of hospital. The virtual buckets created using the approach selection parameter 524 is re-organized by the selection parameter with the length of stay factor 528. The buckets now represent a hierarchical list of the potential target ICD codes arranged in a descending or ascending order. If there are ‘n’ choices, then ‘n’ buckets are created on one or more of the parameters. The thing to note is that these buckets do not use absolute values. Rather it constitutes virtual values which will be later re-categorized to actual values. The next step is the use of data mining on historical data to create absolute buckets i.e. the buckets that were created in the step above are assigned values 530. In one embodiment, the actual buckets can be derived from the virtual buckets at compile time. This can be done at the time of processing the codes, and pre-storing these codes.

These buckets are statistically analyzed along the applied selection parameter i.e. the approach selection parameter to allocate actual values to virtual buckets. The statistical analysis is based on the historical data, specific to each hospital, and represents the data of patients previously treated, as the approach and length of stay or other selection parameters, as applicable. These data sets include hospital data such as cost charts, patient information w.r.t to LoS etc. The statistical method applied is the clustering method. Clustering is a division of data into groups of similar objects. Clustering methods partitioned the target ICD code(s) into homogeneous groups such that objects in the same cluster are more similar to each other than objects in different clusters according to some defined criteria. Clustering allows a user to make groups of data to determine patterns from the data. Preferably, the data clustering methods can be hierarchical, top-down approach or divisive. Divisive algorithms begin with a whole set and proceed to divide it into smaller clusters. Some clustering techniques include k-Means, EM etc. In one embodiment, clustering is extended by the use of k-means algorithm to categorical domains and domains with mixed numeric and categorical values. The k-modes algorithm uses a simple matching dissimilarity measure to deal with categorical objects, replaces the means of clusters with modes, and uses a frequency-based method to update modes in the clustering process to minimize the clustering cost function. With these extensions the k-modes algorithm enables the clustering of categorical data in a fashion similar to k-means. Since some implementations of K-means only allow numerical values for attributes, it may be necessary to convert the data set into the standard spreadsheet format and convert categorical attributes to binary. Traditional data mining techniques is applied for fixing values for the buckets. The associations are developed using correlations to develop association rules using clustering techniques and patient data. Based on the actual values 530 and the secondary ICD codes and the diagnostic codes, matching target ICD codes are selected by the system 532. If the resulted target ICD code is multiple 534 then the system may be configured to accordingly implement the next second axis of differentiation 536 in the manner described above. Alternatively, the resultant codes could be marked for a manual review. If the implementation of the selection parameter yields a mirror mapping then the single target ICD code is stored as the desired output 508. Target ICD codes are generated in the form of an output or the input files are updated with the converted code at the appropriate position in the file.

One skilled in the art would recognize that additional parameters can be used to reduce to target ICD codes, which include, but not limited to, hospital information, medical notes, patient demographics or historical data. The disclosure can be used to understand the total adjusted claim amount which is the claim amount for the principal code adjusted for factors such as wage index, hospital specialty and other factors which typically influence payments, age of patient, length of stay and related diagnosis and procedure codes, amongst others. Other areas include, but not limited to a crosswalk approach where the rules are automatically created and highly specific. While the disclosed system may be implemented for the ICD9-10 version, one skilled in art will recognize that the future version(s) of the classification may also be application for the treatment procedures.

These embodiments may be implemented with software, for example modules executed on computing devices such as computing device 300 of FIG. 3. Of course, modules described herein illustrate various functionalities and do not limit the structure of any embodiments. Rather the functionality of various modules may be divided differently and performed by more or fewer modules according to various design considerations.

Having described and illustrated the principles of the disclosure with reference to described embodiments and accompanying drawings, it will be recognized by a person skilled in the art that the described embodiments may be modified in arrangement without departing from the principles described herein.

What is claimed is:

1. A computer-implemented method of determining one or more target ICD procedure codes based on an axis of differentiation, the method comprising:
identifying diagnostic and procedure ICD codes from an incoming medical service claim record;
implementing a first correlation analysis for a first axis of differentiation, wherein the first axis of differentiation comprises a body structure selection parameter, wherein the first correlation analysis comprises of comparing each of potential target ICD procedure code tokens with at least one stored repository of body parts;
applying a second correlation analysis for at least one of a second axis of differentiation in the event the first correlation analysis yields multiple target ICD procedure codes, wherein the second axis of differentiation comprises an approach selection parameter, an age selection parameter and a cost selection parameter, wherein the second correlation analysis comprises of correlating the potential target ICD procedure code tokens with a set of virtual buckets created for the at least one of axis of differentiation;
performing statistical analysis of historical data along the one or more applied selection parameters of the second axis of differentiation;
allocating actual values to the virtual buckets, wherein the allocation of actual values to virtual buckets is done by associating the virtual bucket values to the statistically analyzed historical data; and
generating the one or more target ICD procedure codes.

2. The computer-implemented method of claim 1, wherein the at least one stored repository of body parts is an electronic database comprising body part medical terminologies.

3. The computer-implemented method of claim 1, wherein the target procedure ICD code is one of an ICD-9 coding system and an ICD-10 coding system.

4. The computer-implemented method of claim 1, wherein the diagnostic and procedure ICD codes identified from the incoming medical service claim record is one of an ICD-9 coding system and an ICD-10 coding system.

5. The computer-implemented method of claim 1, wherein the target procedure ICD code tokens are created by parsing the target ICD procedure code descriptions.

6. The computer-implemented method of claim 1, wherein the virtual buckets correspond to a plurality of singular tokens which are generated based on the applied axis of differentiation.

7. The computer-implemented method of claim 1, wherein the diagnostic ICD codes identified from the incoming medical service claim record is used to allocate actual values to the virtual buckets.

8. The computer-implemented method of claim 1, wherein the correlation of potential target procedure ICD code tokens with at least one stored repository of body parts is supplemented with the information from a claim file.

9. The computer-implemented method of claim 1, wherein the virtual buckets are ranked based on length-of-stay factor or age factor or cost factor or combinations thereof.

10. The computer-implemented method of claim 1, wherein the statistical analysis of historical data applied along at least one of the selection parameters is correlated with the location of a medical service agency.

11. An automated system for determining one or target procedure ICD codes based on an axis of differentiation, the system comprising:
an input terminal for receiving one or more incoming medical service claim record, wherein the medical service claim record is used to identify one or more diagnostic and procedure ICD codes; and
a computing system communicating with the input terminal comprising:
a code analyzer for applying a first axis of differentiation, wherein the first axis of differentiation comprises a body structure selection parameter, wherein the body structure selection parameter is applied by correlating each of the potential target ICD procedure code tokens with one or more stored repository of body parts;
the code analyzer further adapted to apply at least one of a second axis of differentiation in the event the implementation of body selection parameter yields multiple target procedure ICD codes, wherein the second axis of differentiation comprises, comprises an approach selection parameter, an age selection parameter and a cost selection parameter, wherein the at least one of the axis of differentiation is applied by generating a set of virtual buckets from the potential target ICD procedure code tokens;
a code correlator for allocating actual values to the virtual buckets; wherein the actual values allocated to the virtual buckets are used to determine the one or more target ICD procedure codes; and
a code generator for outputting the one or more target ICD procedure codes.

12. The automated system of claim 11, wherein the at least one stored repository of body parts is an electronic database comprising body part medical terminologies.

13. The automated system of claim 11, wherein the target ICD procedure code is one of an ICD-9 coding system and an ICD-10 coding system.

14. The automated system of claim 11, wherein the diagnostic and procedure codes identified from an incoming medical service claim record is one of an ICD-9 coding system and an ICD-10 coding system.

15. The automated system of claim 11, wherein the target procedure ICD code tokens are created by parsing the target ICD procedure code descriptions.

16. The automated system of claim 11, wherein the virtual buckets correspond to a plurality of tokens generated based on the applied axis of differentiation.

17. The automated system of claim 11, wherein the diagnostic ICD codes identified from the incoming medical service claim record is used to allocate actual values to the virtual buckets.

18. The automated system of claim 11, wherein the correlation of potential target procedure ICD code tokens with at least one stored repository of body parts is supplemented with the information from a claim file.

19. The automated system of claim 11, wherein the virtual buckets are ranked based on length-of-stay factor or age factor or cost factor or combinations thereof.

20. The automated system of claim 11, wherein the actual values are allocated by correlating the virtual bucket values with the statistical analysis of historical data.

21. A computer implemented method to determine one or more target procedure classification codes, the method comprising:
identifying at least source disease medical code from an incoming medical service claim record;
creating one or more tokens using potential target procedure classification code descriptions;
correlating the one or more tokens with at least one stored repository of body parts, wherein the at least one stored repository of body parts is an electronic database comprising body part medical terminologies; and
generating the one or more target procedure classification codes.

22. The computer-implemented method of claim 21, wherein the target procedure classification codes is one of an ICD-9 coding system and an ICD-10 coding system.

23. A computer-implemented method to determine one or more target procedure classification codes, the method comprising:
identifying at least source disease medical code from an incoming medical service claim record;
applying a correlation analysis using an approach selection parameter, wherein the correlation analysis comprises of correlating the potential target ICD procedure code tokens with a set of virtual buckets created for the at least one of axis of differentiation;
ranking the set of virtual buckets based on a length-of-stay factor;
performing statistical analysis of historical data along the approach selection parameter;
allocating actual values to the virtual buckets, wherein the allocation of actual values to virtual buckets is done by associating the ranked set of virtual bucket values to the statistically analyzed historical data; and
generating the one or more target ICD procedure codes.

24. The computer-implemented method of claim 23, wherein the tokens are created by parsing the potential target procedure classification codes.

25. The computer-implemented method of claim 23, wherein the target procedure classification codes is one of an ICD-9 coding system and an ICD-10 coding system.
